(19) United States
(12) Patent Application Publication
(10) Pub. No.: US 2003/0152312 A1
(43) Pub. Date: Aug. 14, 2003

(54) Multi-channel optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/170,983

(22) Filed: Jun. 11, 2002

(30) Foreign Application Priority Data
Feb. 8, 2002 (TW) 91201722

(51) Int. Cl. G02B 6/35

(52) U.S. Cl. 385/16

(57) ABSTRACT

A multi-channel optical switch (10) switches light signals from a plurality of input fibers (101) between different permutations of output fibers (201). The optical switch includes an input assembly (100), an output assembly (200), a lightpath-changing assembly (300) and a driving assembly (400). The input assembly is identical to the output assembly. The lightpath-changing assembly comprises two prisms (301,302) which can be rotated by the driving assembly. The light paths from the input fibers to the output fibers are changed by rotation of the two prisms.

### BACKGROUND OF THE INVENTION

1. Field of the Invention

The present invention relates to an optical switch, and particularly to a mechanical optical switch for switching signals from multiple input fibers among multiple output fibers.

2. Description of Prior Art

For purposes of convenience and economy, it is often desirable to employ switches in optical networks, so that either a single optical signal can be shared between two or more users or a single user can choose from a variety of optical signals without the added expense and complexity of installing additional hardware.

Optical switches can be classified as mechanical optical switches or as non-mechanical optical switches. Mechanical optical switches realize changes in lightpaths by moving optical fibers or elements using principles of mechanics or electromagnetism.

Referring to FIG. 1, U.S. Pat. No. 5,907,650 discloses an optical switch comprising a platform 600, an input assembly 610, a plurality of output assemblies 620 and a reflector assembly 630. The platform 600 is used for supporting and fixing the input assembly 610, the plurality of output assemblies 620 and the reflector assembly 630. The input assembly comprises an input fiber 611 and a GRIN lens 612. Each output assembly comprises an output fiber 621 and a GRIN lens 622. The reflector assembly 630 is located in a center hole 601 of the platform 600 and comprises a reflector 631 and a base 632 for fixing the reflector 631. A hole 633 is defined in the base 632 for accepting a driving device (not shown). The input assembly 610 is perpendicular to the platform 600 and is at a forty-five degree angle with respect to the reflector 631. The plurality of output assemblies are disposed parallel to and on the platform 600, in a circular arrangement surrounding the reflector assembly 630. The reflector assembly 630 is rotated by the driving device to selectively output light from the input fiber 611 to one selected output fiber 621. Additionally, the reflector assembly 630 can direct light input light from a selected output fiber 621 into the input fiber 611.

However, the optical switch has some shortcomings. First, the output assemblies of the optical switch are independent, thus making the structure of the optical switch very large, and making alignment of the input assembly with the output assemblies very difficult. Second, each output assembly comprises an output fiber 621 and a GRIN lens 622, thus making the optical switch high in cost, with a high insertion loss and with a low switching speed. Third, the optical switch is a one-to-many light switch, not a many-to-many light switch, which is desired.

An improved many-to-many optical switch having a low cost, low insertion loss and high switching speed is desired.

An example of an optical switch is disclosed in co-pending application, U.S. Ser. No. 10/098325, filed on Mar. 15, 2002 by the same assignee as this application. It is hereby incorporated by reference. Another copending application with an unknown serial number filed on June 10, titled “OPTICAL SWITCH”, with the same inventor and the same assignee as the invention, discloses an approach.

### SUMMARY OF THE INVENTION

Accordingly, an object of the present invention is to provide an optical switch having a low cost, low insertion loss and high switching speed.

Another object of the present invention is to provide a many-to-many optical switch.

To achieve the above objects, a multi-channel optical switch in accordance with the present invention comprises an input assembly, an output assembly, a lightpath-changing assembly and a driving assembly. The input assembly is identical to the output assembly and has a plurality of optical fibers terminated in a ferrule and a collimator lens. The lightpath-changing assembly comprises two prisms which can be independently rotated by the driving assembly. The light paths from input fibers to output fibers change as the two prisms rotate, which switches light transmissions from the input fibers to selected permutations of the output fibers.

### BRIEF DESCRIPTION OF THE DRAWINGS

FIG. 1 is a perspective view of a conventional optical switch;

FIG. 2 is a perspective view of a multi-channel optical switch in accordance with the present invention;

FIG. 3 is a cross-sectional view of the multi-channel optical switch of FIG. 2 taken along line III-III;

FIG. 4 is cross-sectional view of the multi-channel optical switch of FIG. 2 taken along line IV-IV; and

FIG. 5 and FIG. 6 are schematic views of two different light paths created by operation of the multi-channel optical switch in accordance with the present invention.

### DETAILED DESCRIPTION OF PREFERRED EMBODIMENT

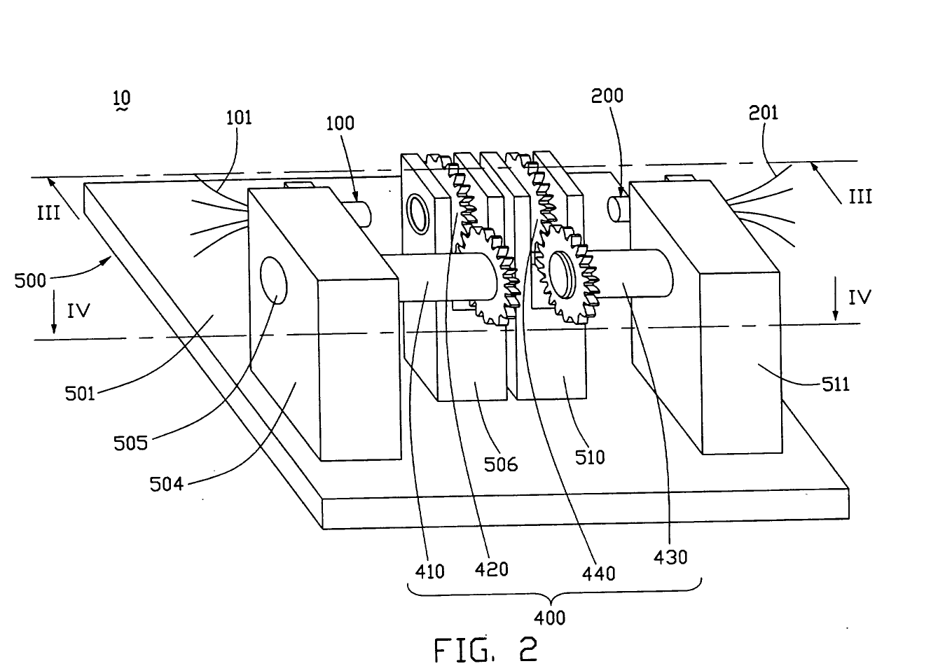

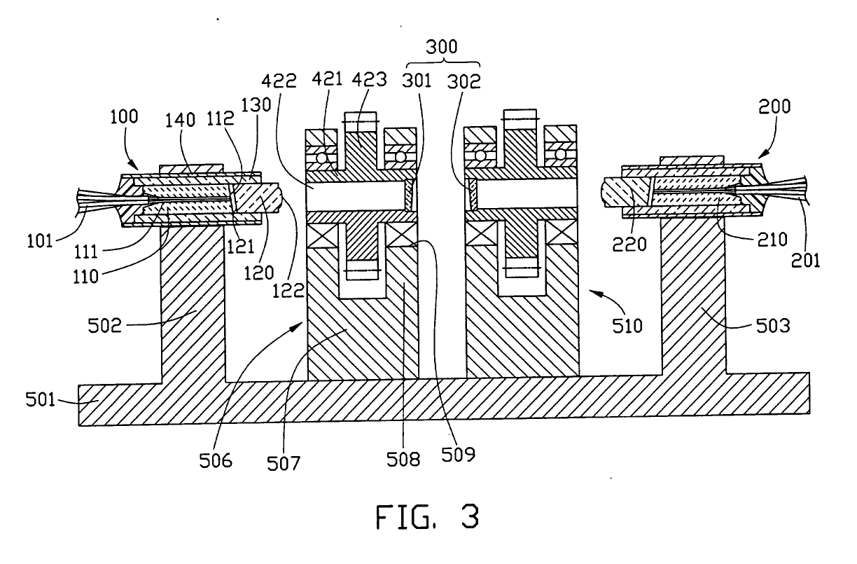

Referring to FIGS. 2 and 3, a multi-channel optical switch 10 in accordance with the present invention comprises an input assembly 100 with a plurality of input fibers 101, an ouput assembly 200 with a plurality of output fibers 201, a lightpath-changing assembly 300 and a driving assembly 400. The optical switch 10 further comprises a substrate 500 for supporting the above mentioned elements. The substrate 500 comprises a base 501, and perpendicularly extending from the base 501, two first supporting plates 502, 503 for respectively supporting the input assembly 100 and the output assembly 200, and two second supporting plates 504, 511, and two third supporting plates 506, 510. The six supporting plates related above are parallel to each other.

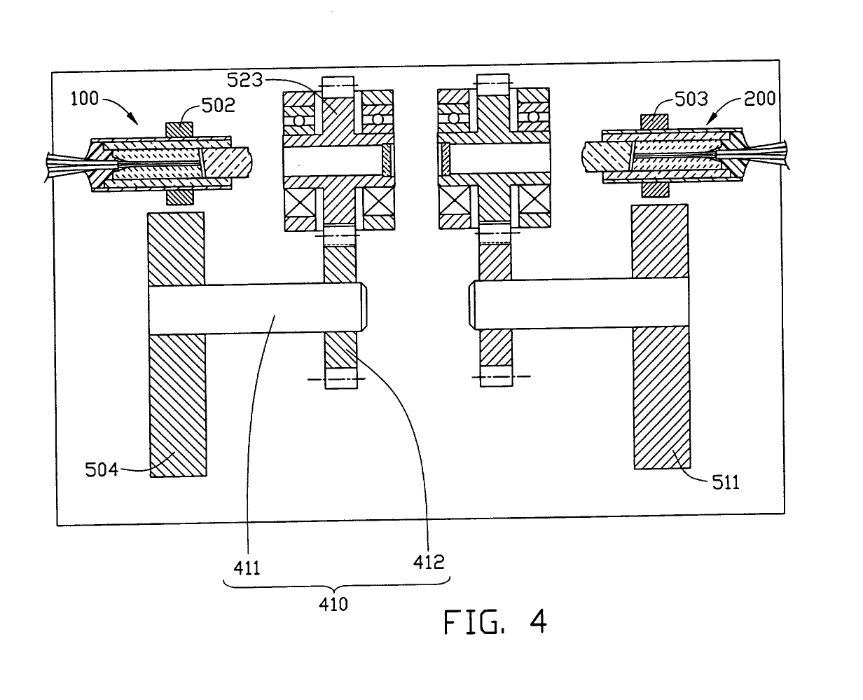

Also referring to FIG. 4, the input assembly 100 fixed on the first supporting plate 502 comprises a ferrule 110 with a plurality of input fibers 101 fixed therein and an input collimator lens 120 which collimates light transmitted from input fibers 101 to the lightpath-changing assembly 300. The collimator lens 120 can be a GRIN lens or a molded lens. A channel 111 is defined axially through a center of the ferrule 110 for accommodating the plurality of input fibers 101. In order to reduce return insertion losses, one end surface 112 of the ferrule 110 is ground to a 4 to 8 degrees slanted surface. A rearward end surface 121 of the collimator lens 120 facing the ferrule 110 is ground to be parallel to the end surface 112 of the ferrule 110. A forward end 122 of collimator lens 120 can be aspherical in shape. The ferrule 110 with the plurality of input fibers 101 therein and the collimator lens 120 are fixed in a quartz tube 130, and a portion of the collimator lens 120 extends from the quartz tube 130. A metal tube 140 is assembled over the quartz tube 130 to protect the quartz tube 130.

The output assembly 200 is substantially identical to the input assembly 100, and comprises a ferrule 210 accepting a plurality of output fibers 201 and an output collimator lens 220 at a forward end of the ferrule 210. The collimator lens 220 focuses light from the lightpath-changing assembly 300 into the output fibers 201. The output assembly 200 is fixed on the first supporting plate 503.

The lightpath-changing assembly 300 comprises a first prism 301 and a second prism 302. The input collimator lens 120 changes light from the input fibers 101 into parallel light. The parallel light is deviated a particular angle, first by the first prism 301, then by the second prism 302, and is then focused down by the output collimator lens 220 for transmission by the output fibers 201. The first and second prism 301, 302 can be independently rotated to realize optical transmission between the input fibers 101 and different permutation of the output fibers 201.

The driving assembly 400 comprises a first active part 410, a first passive part 420, a second active part 430 and a second passive part 440. The first active part 410 and the first passive part 420 together rotate the first prism 301. The second active part 430 and the second passive part 440 together rotate the second prism 302. The first and second active parts 410, 430 are respectively rotatally mounted to the two second supporting plates 504 and 511 and are respectively connected to outside outer driving devices (not shown). The first and second passive parts 420, 440 are respectively rotatally mounted in the two third supporting plates 506 and 510.

The first active part 410 comprises a pole 411 and a first active gear 412 formed at one end of the pole 411. The other end of the pole 411 is supported in a hole 505 of the second supporting plate 504 and is connected to a first outside driving device (not shown). The first passive part 420 comprise a cylindrical body 421 and a first passive gear 423 in a middle thereof. The third supporting plate 506 has a U-shaped structure with a base 507 and two arms 508, each of which defines a hole 509 therethrough. Two ends of the cylindrical body 421 are respectively supported in the holes 509 of the two arms 508, the first passive gear 423 being located in the space between the two arms 508. A passageway 422 is defined through a center of the cylindrical body 421 for accommodating the first prism 301. The first outside driving device drives the first active gear 412 to rotate, and since gear teeth (not labeled) of the first active gear 412 match with gear teeth (not labeled) of the first passive gear 423, the first passive gear 423 and the first prism 301 fixed in the first passive gear 423 rotate with and in a direction counter to the first active gear 412.

The second active part 430 and the second passive part 440 are substantially mirror images of the first active part 410 and the first passive part 420, respectively. The second prism 302 can be rotated by the driving of a second outside driving device (not shown). Thus, the light from the input assembly 100 can be selectively deviated by the first prism 301 and by the second prism 302 for transmission by a preselected combination of output fibers 201 in the output assembly 200.

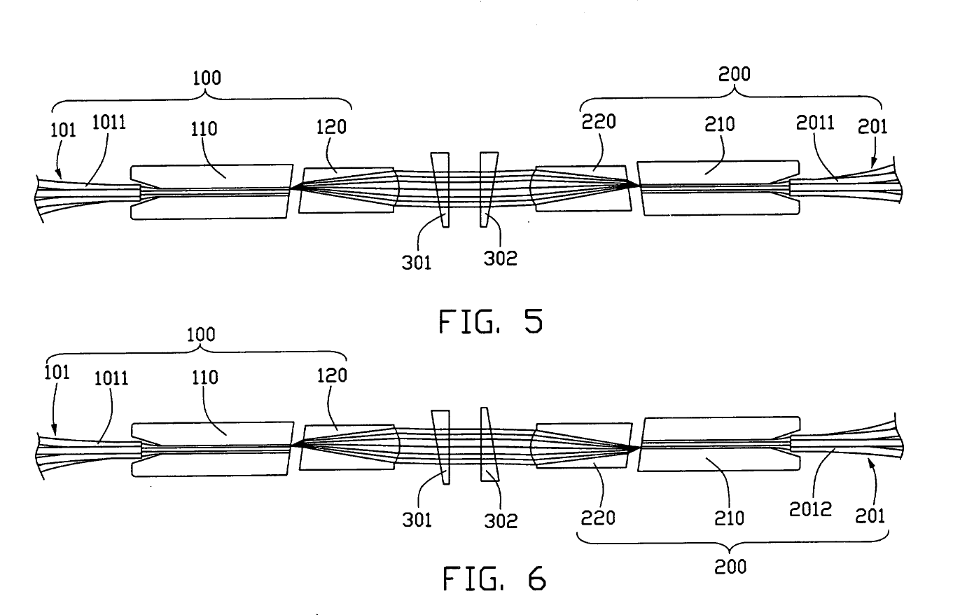

FIGS. 5 and 6 are schematic drawings of two respective light paths through the optical switch 10 in accordance with the present invention. The light from an input fiber 1011 changes into parallel light by passing through the input collimator lens 120. The parallel light is deviated two times, first by passing through the first prism 301 and then by passing through the second prism 302, and the output collimator lens 220 focuses the light down into an output fiber 2011. In FIG. 6, the second prism 302 has been rotated to another position. The light from the same input fiber 1011 now receives a different deviation by the second prism 302, and is redirected to output by a different output fiber 2012. The rotation of the first and second prisms 301, 302, can direct the light from the input fibers 101 to selected different permutations of the output fibers 201.

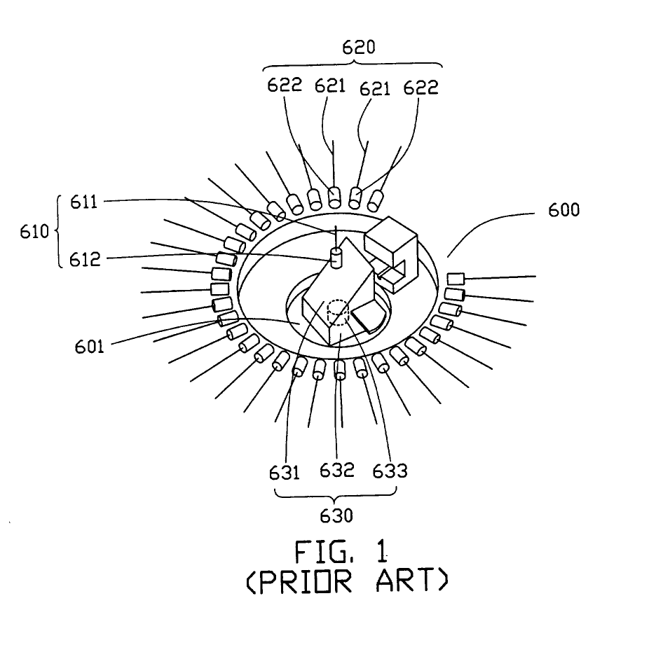

Compared with conventional technology, the multi-channel optical switch 10 in accordance with the present invention has an input assembly 100 with a plurality of input fibers 101, an output assembly 200 with a plurality of output fibers 201, and only two collimator lenses 120, 220. Thus, the structure is much simpler and less costly than the prior art shown in FIG. 1, with its many GRIN lenses. Assembly is also easier and less time consuming since the input and output fibers 101, 102 are fixed in only two ferrules 110, 210, and only the two collimator lenses 120,220 need be attached to the ferrules 110, 210.

Although the present invention has been described with reference to a specific embodiment, it should be noted that the described embodiment is not necessarily exclusive and that various changes and modifications may be made to the described embodiment without departing from the scope of the invention as defined by the appended claims.

What is claimed is:

1. A multi-channel optical switch comprising:
an input assembly including a ferrule with a plurality of input fibers;
an output assembly including a ferrule with a plurality of ouput fibers;
a lightpath-changing assembly including at least two prisms located between the input assembly and the output assembly; and
a driving assembly for driving the lightpath-changing assembly to change the position of the prisms between a plurality of predetermined positions;
wherein, each different combination of prism position produces a different predetermined light path from each input fiber, resulting in receipt of the input signal from a given input fiber by a different predetermined output fiber.

2. The multi-channel optical switch in accordance with claim 1, wherein the input assembly includes a lens to collimate light from the input fibers for transmittal through the lightpath-changing assembly.

3. The multi-channel optical switch in accordance with claim 2, wherein the collimator lens is a molded lens.

4. The multi-channel optical switch in accordance with claim 1, wherein the output assembly includes a lens to focus light from the lightpath-changing assembly into the output assembly.

5. The multi-channel optical switch in accordance with claim 1, wherein the driving assembly includes a plurality of active elements and a plurality of passive elements, and the active elements drive corresponding passive elements.

6. The multi-channel optical switch in accordance with claim 5, wherein each passive element has a hole for accommodating a corresponding prism.

7. The multi-channel optical switch in accordance with claim 1 further comprising a substrate for fixing and supporting the input assembly, the output assembly, the lightpath-changing assembly and the driving assembly.

8. A multi-channel optical switch comprising:
an input assembly including a ferrule with a plurality of input fibers;
an output assembly including a ferrule with a plurality of ouput fibers;
a lightpath-changing assembly including a first prism and a second prism located between the input assembly and the output assembly; and
a driving assembly;
wherein, when the driving assembly rotates to a particular position, at least one of the first and second prisms change position so that the first prism redirects light signal transmitted from the input assembly to the second prism in a predetermined direction and the second prism redirects the light signal thereby received the plurality of output fibers of the output assembly, a signal from a given input fiber being redirected to a given, predetermined output fiber.

9. The multi-channel optical switch in accordance with claim 8, wherein the input assembly further comprises a collimator lens for collimating the light from the input fibers for transmittal through the lightpath-changing assembly.

10. The multi-channel optical switch in accordance with claim 8, wherein the output assembly further comprises a collimator lens for focusing the light from the lightpath-changing assembly into the output fibers.

11. The multi-channel optical switch in accordance with claim 8, wherein the driving assembly comprises two active elements and two passive elements and the active elements drive corresponding passive elements.

12. The multi-channel optical switch in accordance with claim 11, wherein each passive element has a hole for accommodating a corresponding prism.

13. A multi-channel optical switch comprising:
an input assembly with a plurality of input fibers generally densely arranged together in a first holder;
an output assembly with a plurality of output fibers generally densely arranged together in a second holder generally aligned with said first holder; and
first and second optical deflection elements positioned between said input assembly and said output assembly; wherein
said first optical deflection element is moveable to different positions, at least either linearly or curvedly, to correspond to the different input fibers, thus respectively adjusting/regulating different lights from said different input fibers, in a one-on-one relationship at each time, to be along a common light path, while said second optical deflection element is moveable to different positions, at least either linearly or curvedly, to correspond to the different output fibers, thus respectively adjusting/regulating said different lights in said common path toward said different output fibers, selectively, in another one-on-one relationship at each time.
